(19) United States
(12) Patent Application Publication
(10) Pub. No.: US 2021/0357791 A1
(43) Pub. Date: Nov. 18, 2021

(54) SYSTEM AND METHOD FOR STORING AND PROCESSING DATA

(71) Applicant: Ilya Nikolaevich LOGINOV, Moscow (RU)

(72) Inventor: Ilya Nikolaevich LOGINOV, Moscow (RU)

(21) Appl. No.: 16/232,324

(22) PCT Filed: Aug. 31, 2018
(86) PCT No.: PCT/RU2018/000576

§ 371 Date: Jul. 23, 2021

(51) Int. Cl. G06N 5/04; G06F 16/901; G06F 16/906; G06F 16/904

(52) U.S. Cl. CPC G06N 5/043; G06F 16/904; G06F 16/906; G06F 16/9024

(57) ABSTRACT

The present invention relates to a method for storing data that is executed on an electronic computing device, the method comprising the following steps: obtaining information about an information object from the environment in the form of a dataset; from the dataset, generating at least two information entities, wherein the second information entity is the binding property of the first information entity in the form of two afferent graph nodes; for each of the two afferent graph nodes, generating at least one intermediate graph node, wherein the at least one intermediate graph node has at least one input from at least one afferent graph node or intermediate graph node; generating connections between the first afferent graph node and the second afferent graph node, wherein said connections are made through intermediate graph nodes; and storing the generated graph nodes in at least one graph database that is represented by at least one matrix in machine-readable memory of said electronic computing device or of an external device that is connected to said electronic computing device.

The present invention also relates to a system for storing and processing data, comprising: a data input interface for inputting information about an information object in the environment and for converting the inputted information into at least one dataset; an information converter that converts the information into at least one dataset and sends the dataset into an afferent cognitive converter; an afferent cognitive converter represented by a software module for converting the dataset into cognitive frames, the cognitive frames being information structures consisting of cognitive information quanta that are discrete for an intelligence, wherein at least two information entities are generated from the dataset, wherein the second information entity is the binding property of the first information entity in the form of two afferent graph nodes; and a cognitive memory software module that is capable of: creating and storing information structures as afferent graph nodes; creating and storing intermediate graph nodes for afferent graph nodes, wherein intermediate graph nodes have at least one input from at least one afferent graph node or intermediate graph node; and creating and storing connections between afferent graph nodes, wherein said connections are made through intermediate graph nodes.

The present application claims priority to PCT Application PCT\RU2018\000576 filed on Aug. 31, 2018, entitled “ [symbol] [symbol] [symbol] [symbol] [symbol] [symbol] . The application is incorporated by reference herein in its entirety.

### FIELD

The present invention relates to a system and method for storing data, particularly, to a system and method for storing and processing data.

### DESCRIPTION OF THE RELATED ART

The development of various methods for intelligent systematization of information, including storage of data, for instance, using neural solutions, such as neural networks and hierarchical memory systems, has been long underway. However, all solutions (particularly, methods) that have been created so far, are usually restricted to purely applied solutions for solving narrow (e.g. in a local subject area) sets of tasks, particularly, in the field of information/data recognition, such as text recognition or image recognition (using templates, reference points, etc.), particularly, static images, such as digital images, images on paper, on human retina, or images displayed on electronic device screens, and of objective systematization of such information. Said solutions are not able to recognize logical connections of this information/data in the space-time continuum (i.e. within a physical model that supplements the spatial dimension with an equal temporal one in order to create a theoretical physical construct known as the “space-time continuum”), thus making it impossible to create systems capable of reacting to unpredictable information, e.g. predicting and reacting to the behavior of an object/information object/environment object that has never been encountered before either in the environment/physical world or in the system or information storage device that utilize the claimed method, according to the set of goals.

Conventional methods for storing and processing data/information, particularly, neural networks, superimpose information on the experience accumulated by these networks and respond to a data query or a problem with a ready solution, regardless of the type and kind of information stored in these networks or fed into these networks.

Also, existing neural networks have no mechanism for systematizing causal connections between information objects, no mechanism for step-by-step decision making, and no method for systematizing abstractions, and their application to newly acquired data requires them to be adjusted to a narrow set of tasks.

There is another conventional method for storing and processing data/information, particularly, a hierarchical temporal memory, which is limited by the physical constitution of a biological neuron. Using a more complex artificial neuron model, which is, however, a simplified natural/biological neuron model, the hierarchical memory system is still unable to solve a number of problems of time and space, thus rendering application of the methods utilized by said system virtually impossible. This has not been implemented so far. For instance, the hierarchical temporal memory system superimposes input information one on another, which leads one to presume that the system has to utilize infinite hardware capacity, while also simulating ordinary video feed, wherein all images have been structured in advance.

Therefore, there is currently no system or method for storing, processing and systematizing information that would allow to create applied systems capable of tackling large slices (volumes) of information, particularly, cognitive connections between objects, including abstract connections and causal connections.

Therefore, based on the analysis of the prior art and technical capabilities, there is a need in the field for a system and method for storing and processing data.

### SUMMARY

The objective of the present invention is to expand functional capabilities of data storage and processing by means of complex analysis of input data on environment objects and connections between them taking into account source data on the environment objects, that contain information about the connections between the environment objects, as well as by means of storage of input data in the form of graph nodes in a graph database represented by a matrix in machine-readable memory of an electronic computing device or of an external device that is connected to said electronic computing device.

In accordance with one aspect of the present invention, there is proposed a method for storing data that is executed on an electronic computing device, the method comprising the following steps: obtaining information about an information object from the environment in the form of a dataset; from the dataset, generating at least two information entities, wherein the second information entity is the binding property of the first information entity in the form of two afferent graph nodes; for each of the two afferent graph nodes, generating at least one intermediate graph node, wherein the at least one intermediate graph node has at least one input from at least one afferent graph node or intermediate graph node; generating connections between the first afferent graph node and the second afferent graph node, wherein said connections are made through intermediate graph nodes; and storing the generated graph nodes in at least one graph database that is represented by at least one matrix in machine-readable memory of said electronic computing device or of an external device that is connected to said electronic computing device.

In an exemplary embodiment of the present invention, each graph node is stored in the form of a unique identifier.

In an exemplary embodiment of the present invention, each graph node is assigned a unique identifier, when being stored.

In an exemplary embodiment of the present invention, the connection between the first afferent node and the second afferent node is made through an intermediate graph node.

In an exemplary embodiment, the present invention further comprises creating an intermediate node that results from the connecting at least one afferent node to at least one intermediate graph node, or at least one afferent node to at least one afferent graph node, or at least one intermediate node to at least one intermediate graph node.

In an exemplary embodiment, the present invention further comprises generating, from the dataset or a different dataset, an information entity that is an action performed on at least one information entity of claim 1, in the form of an efferent graph node; and generating at least one connection between at least one intermediate graph node and the efferent graph node.

In an exemplary embodiment of the present invention, connections to efferent nodes are generated based on the analysis of graph nodes, and/or the creation of afferent graph nodes and/or intermediate graph nodes.

In an exemplary embodiment of the present invention, said graph is a quasi graph, in which at least one connection between at least two connections in the graph is stored in the form of at least one node, and/or at least one connection between at least two graph nodes is stored in the form of at least one graph node, and/or at least one connection between at least one graph node and at least one connection is stored in the form of at least one graph node.

In an exemplary embodiment of the present invention, the information about an information object from the environment in the form of a dataset is obtained via a data input interface.

In an exemplary embodiment of the present invention, the data input interface is represented by a user interface capable of inputting at least one input dataset.

In an exemplary embodiment of the present invention, the generated graph nodes are used to create at least one intermediate graph node and/or at least one afferent graph node and/or at least one efferent graph node.

In an exemplary embodiment of the present invention, a set of generated intermediate graph nodes constitute a logic that is used to systematize the information that is stored in the graph in the form of generated nodes.

In an exemplary embodiment of the present invention, datasets contain information about at least one environment object and a description thereof.

In an exemplary embodiment of the present invention, an intermediate node is a first-order intelligence representing an abstract connection between environment objects, from the general to the specific.

In an exemplary embodiment of the present invention, an intermediate node is a second-order intelligence that characterizes changes in environment objects as a time function.

In an exemplary embodiment of the present invention, an intermediate node is a third-order intelligence representing a causal connection between datasets and/or environment objects.

In an exemplary embodiment of the present invention, environment objects are recognized by comparing generated graph nodes and/or connections between them.

In an exemplary embodiment of the present invention, intermediate nodes are generated for an unrecognized environment object, wherein no afferent graph nodes or efferent graph nodes had been generated for said unrecognized environment object before.

In an exemplary embodiment of the present invention, an unrecognized object is recognized using at least one dataset corresponding to that unrecognized object and that has been stored in the form of an afferent graph node, and/or using at least one database that has been stored before in the form of an afferent graph node, and/or using at least one intermediate graph node that has been created before.

In an exemplary embodiment of the present invention, the at least one dataset stored in the form of an afferent graph node, and/or at least one intermediate graph node describes an environment object that is different from the unrecognized environment object, wherein connections are created between such afferent graph nodes and/or intermediate graph nodes to connect them to afferent graph nodes and/or intermediate graph nodes, said connections describing the unrecognized environment object in order to accumulate information about logical connections between recognized environment objects and the unrecognized environment object, thus predicting the behavior of said environment object.

In an exemplary embodiment of the present invention, information entities are generated using a dictionary of afferents, in which each afferent corresponds to at least one graph node.

In an exemplary embodiment of the present invention, an information entity is connected to an afferent node through at least one intermediate node.

In an exemplary embodiment of the present invention, afferent nodes contain data that have been converted by means of an afferent cognitive converter, which is capable of converting the dataset into at least one cognitive frame, each cognitive frame being at least one information structure consisting of cognitive information quanta/information fragments that are discrete for an intelligence.

In an exemplary embodiment of the present invention, at least one graph node is generated in the form of a quantum graph node, which represents the highest level of abstraction and an input for at least one intermediate graph node that contains a dataset description.

In an exemplary embodiment of the present invention, a matrix is a 3D matrix, in which intersections of X, Y, and Z axes contain 1s and 0s, while the axes themselves represent identifiers (IDs) or afferents.

In an exemplary embodiment, the present invention further comprises transforming the at least one generated graph node into at least one connection between graph nodes, and/or into at least one intermediate graph node, and/or into a different afferent graph node, and then storing at least one such graph node in the graph database.

In accordance with another aspect of the present invention, there is also proposed a system for storing and processing data, comprising: a data input interface for inputting information about an information object in the environment and for converting the inputted information into at least one dataset; an information converter that converts the information into at least one dataset and sends the dataset into an afferent cognitive converter; an afferent cognitive converter represented by a software module for converting the dataset into cognitive frames, the cognitive frames being information structures consisting of cognitive information quanta that are discrete for an intelligence, wherein at least two information entities are generated from the dataset, wherein the second information entity is the binding property of the first information entity in the form of two afferent graph nodes; and a cognitive memory software module that is capable of: creating and storing information structures as afferent graph nodes; creating and storing intermediate graph nodes for afferent graph nodes, wherein intermediate graph nodes have at least one input from at least one afferent graph node or intermediate graph node; and creating and storing connections between afferent graph nodes, wherein said connections are made through intermediate graph nodes.

In an exemplary embodiment, the present invention further comprises creation and storage of an information entity from at least one dataset by means of the cognitive memory module, the information entity being an action performed on at least one information entity, in the form of an efferent graph node.

In an exemplary embodiment, the present invention further comprises storage of graph nodes in the form of unique identifiers by means of the cognitive memory module, wherein the graph nodes are stored in at least one graph database that is represented by at least one matrix in machine-readable memory of said electronic computing device or of an external device that is connected to said electronic computing device.

### BRIEF DESCRIPTION OF THE ATTACHED FIGURES

The objects, features and advantages of the invention will be further pointed out in the detailed description as well as the appended drawings. In the drawings:

FIG. 1 shows an exemplary embodiment of the CIS system according to the present invention.

FIG. 2 shows an exemplary user interface (logic navigator).

FIG. 3 shows an exemplary cognitive relativistic information field (topological field) according to the present invention.

FIG. 4A shows a generic graph.

FIG. 4B shows an exemplary graph entry in the form of a matrix.

FIG. 5 shows a matrix (particularly, an adjacency matrix) of an information field (represented by a quasi graph) in the CIS system according to the present invention.

FIG. 6 shows exemplary training and functioning of the CIS system, wherein information is stored in the form of a graph and an adjacency matrix.

FIG. 7 shows an exemplary general-purpose computer system.

### DETAILED DESCRIPTION OF THE PREFERRED EMBODIMENTS

Possessing a storage of knowledge (e.g. stored in the form of data in the claimed system, particularly, on a digital data storage device, such as a hard disk drive, RAM, etc.), particularly, represented by accumulated logical connections between information objects (i.e. objects, the information about which is inputted into the claimed system, e.g. via a data input interface), which may also be connections, the claimed system, as disclosed herein, is able to determine, or, in a specific case, predict, at least one of the possible behaviors of the information object, whereas there is no information/data (stored) about such type of behavior or such information object in the claimed system. Specifically, the object's behavior is determined/predicted, and/or an unknown information object (i.e. one unrecognized by the claimed system) is recognized, using the information/data (so-called experience of the claimed system) that has been previously stored, which describes different objects (particularly, information objects that bear some similarities to the unknown information object, e.g. in their appearance, size, color, speed, behavior, etc.) and so can be applied to such unknown objects, thus accumulating information about logical connections between information objects and making new connections between the unknown object and, for example, other information objects, while also predicting behavior of that information object.

Particularly, as will be described below, the information entity of the object (information object) is a subjective representation/reflection of the object in a data format that presents the properties which have been stored (seen) by the claimed system. In an exemplary embodiment of the present invention, an information entity is a reflection of a real-world entity, such as an environment object, relative to the generated graph/quasi graph, so that, in an exemplary embodiment, the graph/quasi graph is generated based on the information entities that have already been created. The information that is inputted into the system (specifically, externally/from the environment) in the form of datasets is used by the system to generate information entities, wherein one of the information entities may be a binding property (e.g. describing the behavior of an environment object represented by at least one information entity, or describing a attribute/property of an environment object, such as color, size, kind, etc.) of the first information entity. Please note that information entities may be represented by graph nodes, e.g. by afferent graph nodes and/or efferent graph nodes, where graph nodes (particularly, efferent graph nodes, afferent graph nodes, and other graph nodes) may be connected through at least one intermediate graph node, wherein this intermediate graph node has at least one input from at least one afferent graph node or intermediate graph node.

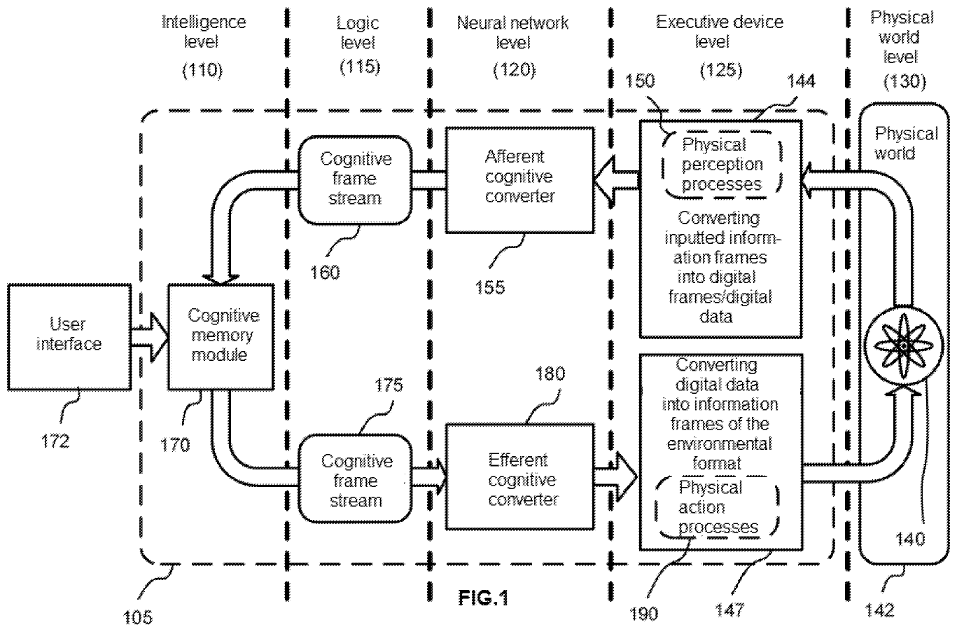

Recognition (recognition phase) is set to be understood as a set of actions/operations aimed at recognition of objects (words, speech, image, including photos, objects in images/photos, etc.) and their structures from the information (a common information stream, as described below) obtained from the environment, particularly, via a data input interface, and converted into a data format (particularly, the format of topological field/quasi graph) to be stored by the claimed system by means of the components on the actuator level 125 (see FIG. 1), neural network level 120 (see FIG. 1), and logic level 115 (see FIG. 1).

Specifically, object recognition means transforming an object (an information object) into an information entity, particularly, based on the existing (and also created and/or stored) data in the graph (quasi graph).

As mentioned above, neural networks on the neural network level 120 are able to answer what the content of the neural network output would be, but they can't answer how said output has been obtained (particularly, the output values, dataset, etc.). In turn, the logic level 115 (also called the book level or the formal logic level), in an exemplary case, is able, at least partially, to answer the “how”-question, i.e. to arrange recognized objects logically. The logic level contains afferents (at least one dataset contained in at least one afferent node) that are structured according to formal logic. Books provide a simple example of such structured data. Specifically, the writer's lexicon is formatted (structured) into logical structures. For example, a sentence from a book: “A cat leapt onto the table to catch a mouse, but overshot and fell down, as the table was slick.” In this example, the words (clearly defined by the writer) have been formatted into formal logic structures. The same applies to graphic diagrams of various processes, particularly, to program code written in a programming language. The writer may put some of his ideas into the book, but it will not make the book an intelligence, in the same way as a song record is not a singer. A book (particularly, an e-book) can't provide answers or solutions to problems posed to it using knowledge inputted into it, just as a medical textbook won't be able to diagnose a disease using patient's symptoms uploaded into it. A book/textbook is a storage of logically formatted information. In turn, the information from a medical textbook, which has been stored using the claimed method (CIS method), may be used by the CIS system (e.g. by means of the user interface 172, specifically, a GUI, or by means of external devices connected to the claimed system, such as screens, speakers, etc., as disclosed herein) to generate a dataset (output data, output dataset, set of output data) that represents, e.g. a diagnosis, particularly, suggestions of illnesses/diseases that the person suffers from, or a course of actions to be taken to treat the patient and/or to refine the diagnosis (e.g. additional tests, diagnostic procedures, etc.), i.e. the dataset represents efferent actions (e.g. in the form of values/datasets contained in efferent nodes). Also, the decision-making process and carrying out of efferent actions (stored in the form of at least one dataset in efferent nodes or of at least one set of efferent node values) may be automated, e.g. by means of a program code and various devices that are connected to the CIS system (e.g. manipulators, automated operating rooms, X-ray scanners, automated labs, etc.), so that the CIS system could make decisions and carry out instructions contained in efferent nodes using stored nodes, as will be described below.

As was mentioned above, the CIS system 105 of the present invention may include the logic level 115, but it is still an intelligence-level system, with a cognitive memory (implemented as the cognitive memory module 172) being its main component, while other components, such as 160, 175, 155, 180, 190, 147, 150, 144, along with their corresponding levels 115, 120, 125 are optional.

As for objects, please note that an object (an information object) is defined by its core and a set of properties. Object attributes are represented by input connections (see below) of the abstractions from other objects to the object core, not only the first-step connections, but also the connections of at least one step or all steps along the ascending tract. Therefore, object detailing, particularly, object description detailing (including at least one object attribute) may be determined by the depth (order) of connections included into the description along the ascending tract in the graph/quasi graph. Object attributes are invariant, i.e. they are created/structured (or computed) relative to other objects in the cognitive memory, particularly, implemented as the cognitive memory module 170 on the intelligence level 110 (see FIG. 1), and not relative absolute environmental units, such as conventional time units, measuring systems or other absolute values. Specifically, the attribute “half-life” of the object “Plutonium” may be inherited from the information object “Atomic clock” or from the information object “Isaac Newton” (who had lived to the age of 84). According to the present invention, the core of an information object (object core) is a graph node (particularly, a node in a quasi graph as disclosed herein (a topological space/field), which is, in fact, a graph, where connections between nodes are represented by graph nodes), in relation to which the connections forming the object attributes are considered.

The information that has passed through the recognition step (processed information, processed information/data stream), according to the present invention, may be exemplified by a set of (rigidly) structured data, particularly, e-books or drawings, wherein their rigid structure after recognition allows to discern the logic in the data. Rigidly structured data, particularly, a rigidly structured book, may also be exemplified by computer code, while a rigidly structured drawing may be exemplified by a drawing made in a computer application, e.g. in AutoCAD by Autodesk. In fact, unlike a drawing made in a computer application, a drawing made on paper is not a rigidly structured drawing, as it has some deficiencies, such as variable line weight or errors in sizes of shapes, e.g. caused by the deficiencies of the drawing tools (ruler, compass, surface gauge, etc.), or by the thickness of the pencil/pen tip, etc. The cognitive information systematizing method (CIS method) disclosed herein allows to discern the logic in information objects (create logical connections between information objects), i.e. the logic of behavior of information objects, the logic of establishing connections between information objects, particularly, the logic of books, and to store information about the object logic and the connections between objects in an invariant form.

The functions of the claimed system and method disclosed herein after the object recognition step are closely connected to the creation of an artificial intelligence, as they allow to solve various task using novel approaches, which is a feature of an artificial intelligence. The CIS system disclosed herein allows to generate a unified knowledge (e.g. unified information about several information objects, the connections between them, etc.) through self-training, by means of creating logical connections, connections for these connections, etc., which allows the claimed system, when new objects or tasks are obtained by it in the form of connections (e.g. via a data input interface), by means of checking the connections between information objects, to find the connections, that are similar (appropriate) for the given information object or action, among the stored (existing in the system) data for similar information objects, and to make decisions, as described above, whereas the information objects mentioned above don't have to be stored (exist) in the CIS system. Conventional data storage and artificial intelligence systems mentioned herein, particularly, formal systems or neural systems are unable to solve such tasks, since formal systems/networks only rigorously follow algorithms that are suited to specific input parameters, while neural networks can't store logic, i.e. can't tell “how” (by what means, methods or ways, using what instruments and data, including information objects) the task has been solved—all unlike the claimed CIS system, which allows to collect and store information objects as a logical whole “how”. As explained above, the closest prototypes of the method for creating an artificial intelligence currently are:
neural networks (suitable for recognition phase only); and
hierarchical temporal memory (doesn't currently allow to create applied systems for a wide range of tasks due to restrictions of the proposed architecture).

Below is the review of the closest prior art to the claimed system and methods for creating an artificial intelligence.

Artificial Neural Networks (ANN)

The theory of neural networks is based on partially copying the structure of a biological neuron (an element of a human brain cell), wherein such copy would be capable of performing at least some elementary transformations and of transmitting data (information) to other neurons, wherein information is transmitted in the form of neural activity impulses of electrochemical nature. An artificial neural network (ANN) is a mathematical model, just as it is implemented by means of computing devices (e.g. computers), wherein an ANN is created following the template of a biological neural network—a complex of neurons in a living organism that are connected or functionally connected to each other to form the nerve system of a living being, capable of performing specific physiological functions. As the structure of a biological neuron—and, particularly, the neuron interaction field—is not sufficiently researched, artificial neurons are based on the physical structure of biological neurons only, for the sake of simplicity. As a result, such mathematical model suffers from a number of significant drawbacks and restrictions:
the logic of information systematization in neural networks is not known (not defined, not used), since it is determined by means of training, so the resulting output is usually approximate and can't be used to provide an accurate answer to the question posed (or to make a specific decision in a specific situation).

In particular, the theory of neural networks is unable to tell “how neural networks make decisions”. Also, a neural network is unable to interact with/manipulate/“operate” the majority of logical chains if it was not taught to recognize those logical chains, since a neural network has to be “trained” for a specific subject area. Therefore, a neural network is unable to find solutions based on some general experience, i.e. information/knowledge about similar logical chains and objects connected to such logical chains, particularly, from different subject areas, since a neural network does not store the decision-making logic, i.e. it doesn't answer the question “how the decision was made”;
neural networks have no mechanism for systematizing causal connections between information objects, no mechanism for step-by-step decision making, and no method for systematizing abstractions, and their application to newly acquired data requires them to be adjusted to a narrow set of tasks. Specifically, existing artificial neural networks are unable to systematize abstractions, which is implemented in the claimed invention, particularly, by the CIS system and method, that allow to systematize abstractions. For instance, if the CIS system has stored information about the information object “sphere” (which is “light”, “rolling”, and “round”), and then a new information object, e.g. “ball” is added, then connections are made/created between the information object “ball” and the information object “sphere”, the connections being, in turn, attributes or a part of attributes of the information object “ball”. Also, the connection between the object “ball” and only several attributes of the object “sphere” may be created, e.g. with the attribute “round” only. Also, if, for example, the information object “ball” has some attributes, such as “rubber”, that the information object “sphere” doesn't have, a connection may be created between the information object “sphere” and the information object “ball”, particularly, with the attribute “rubber” of the object “ball”, or between the attribute “rubber” of the object “ball” and the attribute “rolling” of the object “sphere”. Also, such connections may be created between the information object “sphere” and other similar objects, such as, “planet”, “orb”, etc., which are already stored in the CIS system or may be added into it. Said connections between information objects are stored in the CIS systems to be used to predict behaviors or to establish logical connections between information objects. For example, if the CIS system has the information object “sphere” with the attribute “rolling”, then, when new information objects (“bubble” or “fish egg”) are added, connections may be created between these new objects and the information objects “sphere” and “ball”, particularly, between the new objects and the attribute/connection “rolling” of the information objects already stored in the CIS system, particularly, in its data storage, e.g. represented by the cognitive memory module 170 (see FIG. 1). Said connections, in turn, are themselves attributes of the corresponding information objects, i.e. information objects “bubble” and “fish egg” will be assigned the attribute “rolling” that means they can “roll”, wherein this attribute is also the connection with the attribute “rolling” of the information objects already stored in the system.

Please note that, from the general point of view, artificial neural networks can be regarded as models of an artificial intelligence, so such ANNs may be considered as a prior art to the CIS system and method disclosed herein. Also note that in the context of the CIS system and method disclosed herein, artificial neural networks may serve as complements to CIS systems and methods: specifically, artificial neural networks (particularly, by means of an afferent cognitive converter 155 of the neural network level 120, as disclosed herein) may be used to recognize environment information and convert into cognitive form, where information in cognitive form represents information that can be perceived/understood by a human brain. Therefore, according to the present disclosure, after some information (information objects), e.g. obtained from outside, e.g. from the physical world 142 (environment level 130; see FIG. 1), has been recognized by means of a neural network (neural network level 120; see FIG. 1), e.g. after a text has been recognized, the CIS system is able to recognize the logic of the recognized text and arrange the connections (between information objects and connections between information objects) according to the present invention, particularly, comparing these connections to those that have already been stored in the CIS system (e.g. in the cognitive memory module 170 of the intelligence level 110; see FIG. 1) and storing new information, particularly, about new information objects, in the form of said connections using the data that have already been stored in the CIS system, e.g. data about other information objects, by means of creating connections of the first order (abstractions), second order (changes), third order and so on, as will be described below.

Hierarchical Temporal Memory (HTM)

Hierarchical temporal memory is a particular model of human brain capable of modelling a number of structural and algorithmic properties of neocortex (neopallium, isocortex), based on the memory-prediction theory of brain function. Specifically, a hierarchical memory is described as a biomimetic/bionic mathematical model of cause supposition by an intelligence. One of the main features of the hierarchical temporal memory is its capability to find causes and propose hypotheses about causes.

Authors of this concept, in particular, consider that the hierarchical temporal memory is the closest to the human brain in its operation principles. Hierarchical temporal memory systems allow to eliminate one of the drawbacks of artificial neural networks, namely the issue with temporal components, i.e. hierarchical temporal memory systems are capable of storing temporal components. Since artificial neural networks cannot operate time (particularly, perceive it), they superimpose new information on the experience accumulated in such networks and provide ready solutions to queries, regardless of the information type and kind. In turn, the hierarchical memory disproves this approach as it doesn't create an intelligence/artificial intelligence that would be capable of perceiving time (particularly, of being guided by time) and make decisions (solve actual tasks posed to it) taking time/temporal components into account, e.g. “do something that was planned on the day after tomorrow now, based on the new data obtained by the network”. According to the hierarchical temporal memory concept, time should be represented by connection steps and an additional time value. In turn, the CIS system disclosed herein describes time as a connection between connections, where said connections are nodes/quasi graph nodes, as described below. For instance, the Earth orbits the Sun. The connection between the Earth and the Sun (i.e. the node “the Earth” is connected to the node “the Sun” through the node “day”) is stored in or added into the CIS system in the form of a node, particularly, a node describing time, e.g. the time the Earth needs to make a single circle aroung the Sun. Then, if an information object “car” (also represented by a quasi graph node), which has been moving for a day, is added into the CIS system, it is possible to create a connection between the node describing the movement of the “car” object (e.g. the node “movement”) and the node “day” in order to store information about time, particularly, about the time the information object “car” has been moving for.

Please note that, just like with artificial neurons, the hierarchical temporal memory is limited by the physical structure of a biological neuron. Using a more complex artificial neuron model, which is, however, a simplified natural/biological neuron model, the hierarchical memory system is still unable to solve a number of problems of time and space, thus rendering application of the methods utilized by said system virtually impossible. This has not been implemented so far. For instance, the hierarchical temporal memory system superimposes input information one on another, which leads one to presume that the system has to utilize infinite hardware capacity, while also simulating ordinary video feed, wherein all images have been structured in advance.

However, it should be noted that the hierarchical temporal memory doesn't allow to implement abstract storage of time (as described above), as well as relative perception of time (e.g. by inputting abstract time intervals, abstract durations, abstract dates, etc.), e.g. “until the next drought”. These data cannot be stored using the proposed system and method of hierarchical temporal memory.

Direct knowledge imposition technology, by G. Bronfeld (see http://ww.rf.unn.ru/eledep/confesem/nro_popova/2016_05_23_(62)/01.pdf)

This technology is centered on the idea of structuring information as “molingi” universal information structures carrying/containing ideal knowledge free from ambiguity and empty elements, which are then compared with molingi in the processed texts, but with the same sense. According to this technology, some experts are needed to see similarities of senses, therefore, such technologies usually relate to accumulation of statistical data, not to intelligent systems. Besides, there are no applications of this technology, or any description that could be used to create an applied system capable of solving applied problems like those explained below.

The following disclosure contains description of possible applications of conventional methods and systems of prior art (including those described above) in relation to the present invention.

Currently there are no methods or systems for creating an artificial intelligence that could be widely used, particularly, in day-to-day applications or various applied systems, such as CRM (Customer Relationship Management), ERP (Enterprise Resource Planning), SCADA (Supervisory Control And Data Acquisition), BPMS (Business Process Management System), etc., e.g. for cognitive processing (i.e. processing of data of an information object that do not exist in the CIS system, i.e. not known to the system, wherein the same processing methods are used to process information objects that do exist in the CIS system, particularly, creating connections between information objects, between connections/information object attributes) of information structures that dynamically change as users work with the system, and a user interface adapted to the changed information structure. In other words, the user cannot set the data logic, particularly, information processing algorithms, abstractions between information objects, etc. arbitrarily (particularly, because the majority of programs/applications operate logic by creating new field types or scripts, e.g. in scripting languages, which are rigidly formalized). Specifically, they cannot establish custom links of various natures and abstractions between information objects, being limited by the developers of the system.

Please note that the claimed system and method may be used not only for intellectual (cognitive) data/information processing, but also for creating CRMs and ERPs that allow, for example, to unify all accounting and stocktaking in an organization. However, this may require to teach said system to conduct quantitative accounting (store information using the CIS method as disclosed herein), particularly, to read digits. In this way, the system may use the CIS method to store digits, e.g. from 0 to 9, in afferent nodes, as a base to conduct quantitative accounting. Mathematical operations may be isolated from the claimed system (e.g. like a person uses a calculator, punching in numbers and instructions to obtain final results); also, the claimed system may be taught how to use the multiplication table and/or long multiplication or other mathematical operations by means of the claimed method (CIS method). Therefore, CRM systems, ERP systems, and other systems based on the claimed method and/or system (CIS method, CIS system) would allow to eliminate a major drawback of conventional solutions by bringing different objects together into a unified accounting system.

In turn, neural networks are limited to solving tasks through training methods and systems without generating the cognitive logic for solving tasks. In other words, neural networks are unable to present their decision-making logic in a cognitive form, which makes them virtually unusable for systems, where it is important to utilize business processes or changes in causal connections are of a complex structure (e.g., almost any work of literature, e.g. a fairy tale, has a complex structure that can't be described by means of conventional systems, particularly, by means of neural networks, whereas such complex structures may be described through connections between information objects and connections between connections in the CIS system).

Artificial neural networks cannot be used to solve cognitive tasks (i.e. tasks that a human brain is capable of solving, particularly, based on experience, particularly, on a standard/common world view, as well as using main objects and rules of interaction between objects and with environment objects), supposedly, because artificial neural networks are not designed to solve such tasks, even if we look at real human thinking. All of this inspired the claimed CIS method and system. In particular, the CIS method allows anyone, e.g. a person, to input data into the CIS system, particularly, using a data input interface to input the data/information about information objects, in order to teach the CIS system cognitive basics, i.e. to teach the CIS system to process the inputted or stored information (e.g. while solving various tasks) based on the already stored data that describe similar information with similar properties.

Please note that an artificial neural network is not in fact an artificial intelligence and is used to recognize objects, while an artificial intelligence should be used only after the objects have been recognized. Every animal is able to recognize objects, but only humans have intelligence, specifically, only humans can discern causal connections between information objects in the CIS system and/or information objects in the physical world from the incoming stream of external information, wherein the claimed CIS system and method allow to establish new causal connections in the CIS system, whereas various combinations thereof allow the CIS system to solve a wider range of tasks, even ones that are unknown to the CIS system, i.e. no information about such tasks is stored in the CIS system. Causal connections are a part of connections in the cognitive memory with the depth of more than second level (order) of the continuum (see below). The CIS system disclosed herein does not operate the notions of “past” and “future”, since the cognitive memory does not differentiate the past from the future. For instance, a person may read a speculative futuristic story reliving the events as if they've already happened. A person would regard them as the past, only bearing no relations with reality, no connections to the environment. A person would know this is speculative fiction, since the information is disconnected from reality, but they would still retell the story of the protagonist's adventures as if it were real. In this case, the verisimilitude of the events for the human brain is determined by the correlation of the real-world knowledge, and connections of the objects in the story have a deep continuum (the story is based on text, and reading of texts covers the first and second degree of continuum depth). For instance, the external information is perceived by a person, particularly, by their brain, in the form of a text, e.g. from an e-book, wherein the words of the text are known to the person, and the objects do not have to be recognized by the brain. Besides, having read the book, the person would obtain knowledge and would be able to answer abstract questions, and also to react to the environmental changes they haven't encountered before. The environment is both the source of interconnected information for the cognitive memory and the receiver of the information that has been processed by the cognitive memory. Therefore, the entire information structure created by the CIS method may start and end with the environment. The environment is a single, indivisible object, which is represented in the cognitive memory by one information object core (the environment is indivisible) and attributes (nodes)—the only graph/quasi graph nodes in the cognitive memory that have values to be matched with object cores in the cognitive memory.

The CIS system and method disclosed herein comprise a set of actions, including input, output, and storage of logically connected information in a cognitive form (see below) in order to use it to obtain responses to novel questions, which are unknown to the CIS system (particularly, to its cognitive memory implemented by a cognitive memory (software) module 170), from its cognitive memory, as well as to obtain reactions to events, which are unknown to the cognitive memory (i.e. events that haven't happened before, so that there are no information in the CIS system that would dictate it how to behave, e.g. “event1”->“reaction2”), from the cognitive memory, provided that the new information is described with the set of elements that can be recognized by the system The CIS method may comprise the following actions and elements (to be described in the present disclosure):
description of objects using the CIS method;
input of the incoming information stream into the cognitive memory;
putting of the object into focus;
generation of a dictionary of afferent nodes, i.e. nodes that contain information represented by a dataset, e.g. inputted into the CIS system via a data input interface, wherein said afferent nodes represent input connections/inputs for intermediate nodes (see below);
generation of a dictionary of efferent nodes that contain input data/inputs from intermediate nodes and also contain the data/dataset that is outputted into the environment, e.g. via an I/O interface (e.g. implemented as a user interface), particularly, after it has been converted in the converter 147 and the efferent cognitive converter 180;
training of the cognitive memory, particularly, training of the system disclosed herein;
mathematical representation of the cognitive memory in order to physically store it in conventional data carriers;
reactions of the cognitive memory to information inputs via afferent nodes;
environmental tools.

The claimed CIS method and system, disclosed herein, may be used for logical processing and storage of identified objects, specifically, to establish abstractions and links between said objects, as well as to establish causal connections between information objects in order to obtain solutions to various tasks, including mathematical or logical problems, etc., or to obtain reactions that lead to solutions (e.g. in the form of a prediction of how an information object would behave or as a selected behavior of an information object), wherein reactions may be spatial-temporal, such as forecasts or environment reactions, from the claimed (CIS) system, based on the training of the claimed system (e.g. using the data inputted into the claimed system), Please note that if the claimed system is trained in different ways, different storage structures for information entities may be created, and different reactions (efferents) to the inputting (adding) of the same information objects, data, information, etc. to the claimed system may be obtained, depending on the subject area that was the focus of training of the claimed system.

Please note that training of the CIS system involves detecting causal connections between information objects in the stream of information incoming from the environment, wherein the CIS system sends requests to the environment (see below). Thus, the CIS system is able to establish causal connections in its cognitive memory, based on the environment reaction to the CIS system's requests. An information stream is a set of frames following one another (specifically, information represented by quasi graphs according to the present disclosure, where connections are also considered to be information objects), which, when superimposed on each other, add temporal connections to the spatial connections. Whenever the claimed system compares each following frame/quasi graph with the previous one, it establishes causal connections, which are represented by quasi graph connections.

A connection between objects is an abstraction connection from the general to the specific. In other words, in case with first-order connections, one object is an attribute of another object. Thus, the connection between the objects “person” and “Johnson” will be directed from “person” to “Johnson”, since “person” is an attribute of “Johnson” (a person named Johnson). The connection between the objects “heart” and “person” is directed towards “person”, since “heart” is an attribute of “person”. However, the object “heart” may also be an attribute of other living beings, such as objects “cat”, “dog”, etc. In case the heart is transplanted, its connection is changed in space from one heart to another, i.e. the act of transplantation will be represented by an object with the “transplantation” afferent, which will, in turn, act as a second-order connection between the connections of the replaced heart to the person and the connections of the new heart to the same person. The method of establishing connections between information objects, described above, allows to implement time in the claimed system using the CIS method. If the heart transplantation caused any other changes, e.g. changes in body temperature, such causal connection would connect temporal connections, thus becoming a third-order connection.

By describing an object using the CIS method, it is possible to generate a complete space-time picture of the environment. An object is not represented by a single node—its core—only, but rather by a graph node with all its connections to other graph nodes of various logic depth, as well as with the logical weight of connections. Besides, to describe an object in the language of the environment (i.e. to describe an object by means and/or environment objects and connections between them), some connected nodes may be matched with afferent nodes acting as a link between the environment and cognitive memory, as described above. Thus, the object gets its individual properties (description and attributes, such as speed, size, density, color, beautiful, smart, etc., depending on the type of the object) through connections to other objects (i.e. relative to other objects), which creates a single information space-time continuum within the CIS system, where all objects are interdependent. For instance, the information object “person” has a certain set of attributes, such as height, weight, age, etc., which are represented by connections to other information objects. The node, around which the object attributes are arranged, is known as the object core. Please note that, on the one hand, the object “heart”, mentioned above, is an attribute of a human being, but on the other hand, it also has its own attributes, i.e. said objects describe each other through shared connections, which provides for continuous description of space, wherein one part (of the attributes of an information object, or just some attributes thereof) describes the other, and this description results in a single indivisible object that conforms to logic. Therefore, the CIS system can't support objects that aren't connected to other objects in the CIS system in any way.

In some cases, object cores (see below) do not have direct correlations to afferent node values; they are described by a set of attributes that have correlated afferent node values. For instance, information objects may include people, who are usually described by a pair of attributes, namely, first and last names (and not, say, by an ID code), which are the afferent of the object core for each specific person.

Therefore, an object description (particularly, a full object description) would include at least a graph node (object core) and all input connections.

The claimed CIS method disclosed herein, implemented as the CIS system, may also be used to systematize information (particularly, information objects and connections between them) in the CIS system, so as to establish abstract and causal connections between information objects of any nesting level (see below), as the amount of information in the CIS system would grow, based on which the CIS system would be able to make forecasts using the information stored therein and newly obtained data, e.g. from the environment. Also, the claimed system and method disclosed herein allow to explain the logic of said forecasts, which differentiates the claimed system and method from other forecasting methods and systems, e.g. those based on neural networks.

Please note that said logic may be stored in the CIS system in a cognitive form, which allows to adapt the user interface 172 (see FIG. 1) of the CIS system to the user input (or to any other data input interface that provides external data, particularly, from the environment, or physical world), which makes it easier to recognize new data. The fact that the CIS system according to the present invention is able to represent its decision-making logic in a cognitive form marks yet another difference from neural networks, which are unable to describe their own logic after training and which don't allow to implement a cognitive, input-sensitive user interface.

For systems to operate using the claimed method, it is not necessary to use and/or not necessary to create rigid (non-cognitive) user interfaces. Such systems would also be able to recognize the logic of books, to answer abstract questions based on the recognized information, and also to produce various statements in the course of carrying out the process of relativistic data analysis (i.e. calculation of relative proximity between different abstractions).

The CIS method allows to create cognitive data structures of relativistic logic in any subject area, which is an integral part of any task involving creation of an AI.

In particular, the CIS method:
allows to work with abstract objects of any nesting level and connections between them, wherein such objects/information objects, connections between them and connections between connections may be specified using the CIS system means and used according to the situation depending on the specified initial data that have been inputted into the CIS system, which offers more possibilities to systematize information at the stage of planning of tasks in a given subject area, when exact parameters for making decisions and/or solving tasks are unknown.
allows to store causal connections of information changes of any difficulty in any time range, including the future, wherein a user interface, which allows the user to work with data that have been structured using the CIS method, reflects the basic principles of cognitive thinking, is unified and made independent from the subject area the user works in, i.e. changes in the subject area do not require changes in program code, as well as reduces financial and temporal costs of searching for information and processing it, as it does not require to program complex requests thanks to the structure created by the CIS method, wherein all information has already been found and connected within itself, and the newly added information is connected to the current information through shared properties and logic. Cognitive thinking consists in arranging predictable connections from the focus point based on connected abstractions and moving said focus point towards said predictable connections.
improves information storage security, wherein the logic of the CIS system (structure of connections between objects) may be stored separately from the values of logic objects, whereas the values of logic objects may be stored separately from the logic of the CIS system, e.g. in different information/data storages that are connected with the logic data of the CIS system.
makes it easier for the CIS system to be integrated into/interact (share information) with other external information systems and devices thanks to the fact that both the CIS method and system are based on information relativism principles (see below), are universal and applicable to information structures of other external systems thanks to relativity mechanisms (e.g. mechanisms utilizing special relativity effects, particularly, time dilation, etc.).
recognizes unknown logic and information objects from the information inputted into the CIS system by comparing input values of information objects (initial information object data).

The CIS system and method allow to implement many applied solutions, which do not require any structural changes in the program code that powers the CIS system and method, in a wide variety of fields, such as:
medicine (e.g. medical charts, anatomy atlases, methods of treatment);
personnel management (e.g. information related to employees, such as time sheets, education, important events, promotions/demotions, personal relations), circulation of documents (division of documents into objects to be further analyzed), legal matters (conduction of legal proceedings by connecting and analyzing objects), manufacturing (designing of complex production layouts in a dynamic environment in connection with equipment);
real estate management (construction and taking stock of real estate objects and parts thereof, interaction with documents, engineering communications and events);
fundamental science (working with complex abstract concept and their physical implementation), education (taking stock of personal knowledge, of student knowledge);
marketing (management of clients and deals, as well as of connections between contacts, deals and other stock objects), law enforcement (taking stock and analysis of connected information, detection of illegal schemes);

and many other fields.

The claimed method and CIS system are further defined below. The following description also discloses how the claimed method and CIS system solve applied tasks and problems.

FIG. 1 shows an exemplary embodiment of the CIS system according to the present invention.

In the CIS system implementing the CIS method, an intellect, as an object, is the highest level of abstract information systematization that is necessary to solve tasks involving interaction with the environment—the so-called cognitive information systematization. According to the CIS system 105 disclosed herein, the intellect may operate on at least the following levels and elements listed below (see also FIG. 1), including information converters, such as the afferent cognitive converter 155 and the efferent cognitive converter 180, when the information is inputted into or outputted from the CIS system in the process of its interactions with the environment. Please note that at least one element of the system 105 (including the afferent cognitive converter 155, efferent cognitive converter 180, cognitive memory module 170, information converter 144, etc.), as well as the interface 172, may be implemented as software (e.g. as a computer application, a computer module, a set of algorithms and/or instructions for a computing device) and/or hardware (e.g. as a device connected to the computing device, either via a wired connection, such as USB interface, or via a wireless connection, such as Wi-Fi, Bluetooth, etc., or as a device that is a constituent part of the computing device, such as a PCB, an IC or a set of ICs).

The physical world level 130 represented by the physical world 142 is an environment 140 (physical environment, external environment) which interacts with the intellect and with which the intellect of the CIS system (particularly, one implemented by the cognitive memory module170) interacts. The environment 140 has an information field/relativistic space-time information field (see below), particularly, an infinite information field. A relativistic timespace information field (information field, relativistic field) is, mathematically speaking, a topological space/topological field/quasi graph (a set characterized with an additional structure of a specified type—a topology) that has at least one of the properties of a connected directed weighted graph, where some graph nodes are attributes of other graph nodes, wherein attribute nodes (abstractions) of an object are determined by input connections, the graph nodes from the same topological space being said connections, and wherein the topological space is changed by adding connections between attribute connections, where the graph nodes are represented by graph nodes from the same topological space. Such nesting, as described above, may be infinite, thus defining its space-time continuum.

The unity of space and time is ensured by the fact that time is not a separate element in the CIS method and system. Time is expressed through changes in object attributes in the system, i.e. through creation of new connections between the connections of previous and following changes. Changes in object attributes are an expression of time passage. Therefore, model/standard changes are created, which may then be used to describe time intervals of other changes through relativism (see below).

One of the tasks of an intelligence, which is solved by the claimed solution, is to create and identify abstractions that are needed to make the decisions described by the system, particularly, to predict the behavior of objects/information objects and to recognize those objects.

The environment 140 is connected to the CIS system 105 via at least one executive device (a converting device or an information converter) on the executive device level 125, that allows to convert information from the environment 140 into at least one dataset in the form of digitized information field frames (information frames), and to transmit the converted information frames (e.g. in the form of digital data) to at least one of the components of the CIS system 105, e.g. to the afferent cognitive converter 155. An information frame is a stream of information that comes from the environment 140, which is represented, for example, by a field graph with first-order connections (i.e. spatial connections). Also, the data output module 145 (I/O module) is capable of transmitting data/information from the CIS system 105 (or from at least one component of the CIS system 105, e.g. the efferent cognitive converter 180) into the physical world 142 environment 140 of the physical world level 130.

Executive devices may be divided into at least two types (although, they may be implemented as one information device):
the device 144 (information converter) converting 140 environment data that are inputted into the CIS system 105 from their environment format into the format of the CIS system 105 (particularly, into a digital format that can be processed by computing devices, such as computers, including PCs, servers, etc. using appropriate software) for their further processing, including analysis, converting, storage, etc.;
the device 147 converting data from the CIS system 105 format (digital data format of the CIS system 105) into the environment format.

The converting device 144 may be implemented as, for example, a video camera, a sensor (a temperature sensor, a pressure sensor, a humidity sensor, an air rarefaction sensor, as well as ultrasound, capacitance, magneto-electric sensors, photodiodes/LED, etc.), a microphone, or any other device capable of converting one information type into another.

The converter 147 may be implemented as a display, a TV set, a projector, etc.

The system 105 also includes the neural network level 120, which, in turn, includes the afferent cognitive converter 155—a module that is implemented, for example, as a piece of software executing the algorithm for (immediate) conversion of environment information field frames (i.e. datasets that have been converted into a digital format by the converter 144 in advance) into cognitive frames, particularly, information structures consisting of cognitive information quanta, or, in other words, information fragments that can't be further divided by the intelligence and used to create an abstract model of the environment. For instance, cognitive frames may be represented by words and connections between them. The algorithm of the afferent converter 155 may be an immediate action algorithm (i.e. one that is executed almost immediately), which, for instance, is not used to store information (neither incoming information nor converted information), to analyze information logic or to predict the environment behavior.

Information is inputted into the system using the dictionary of afferents that are recognized by the system, where each afferent (value) may correspond to more than one node of the internal information field (actions are also considered to be objects in the context of the claimed CIS method). Since a graph node is the object core, then one may locate the object and obtain its attributes by comparing several afferent nodes. If the object in question isn't found, a new afferent node may be created to simplify any future searches for this newly created node. Afferent values (afferents) may include words, images, audio recording fragments, etc., particularly those that have been converted by the converter 144.

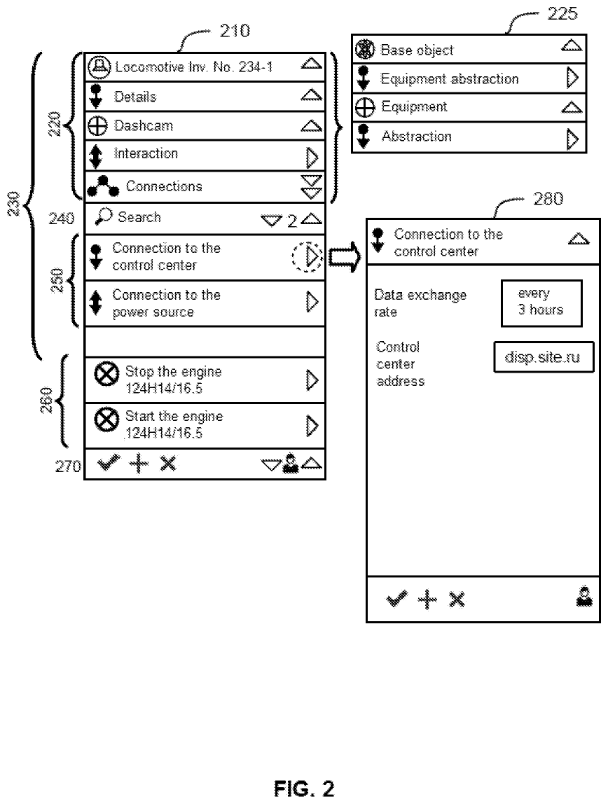

The CIS system interacts with an external information field through information inputs and outputs (by connecting the cognitive memory/internal information field with an external information field). The CIS method is able to process the incoming information, which has been structured as a set of objects of the first-order connections that describe object details and their locations relative to each other in advance. Said information may be contained, for example, in e-books, software source codes, and it does not require cognitive recognition. To work with unstructured information, various image recognition systems may be used, systems based on neural network principles; afferent cognitive converters 155 and efferent cognitive converter 180 may also be used. As mentioned above, the information—in the form of preliminary structured data—may be inputted into the cognitive memory 170 via an interface, including a user interface 172 that may be implemented as a user interface (logic navigator), particularly, the user interface shown in FIG. 2.

Please note that the cognitive memory module 170 may be implemented as at least one data storage, e.g. Random Access Memory (RAM), hard disk drive, net-based data storage (including cloud-based data storages), etc., and may comprise at least one processing unit, e.g. a CPU, or any other device or unit capable of processing information, particularly, processing the data stored in the cognitive memory (e.g. in order to create new nodes, establish connections between nodes, etc., as described in the present disclosure), which is implemented as the cognitive memory module 170.

The set of graph nodes and connections between them forms the content of the cognitive memory. This content by itself is passive and does not elicit any actions from the CIS system towards the environment until the system obtains data that disturb its information balance. The newly obtained information is stored in the cognitive memory cumulatively, i.e. previous information is not changed when new information is added. After new information has been inputted into the CIS system, it would strive for energy optimization, i.e. it would constantly look for structures that correspond to information objects and look like the inputted structure in order to minimize structure storage by means of locating shared abstractions and thus storing the minimum number of object cores. Since object cores are field-generating resonators, by minimizing their number, the system would also minimize the energy costs of data analysis. In fact, the process of thinking (particularly, that of the CIS system, an artificial intelligence, cognitive thinking, etc.) consists in searching for shared structures and combining them into abstractions. This process may be carried out immediately, e.g. at the speed of light, etc., however, due to an enormous number of possible combinations, sometimes equal, i.e. producing similar results for the optimization as described here, this process may cause optimization fluctuations (a spread of results) and transitions from one optimum cognitive thinking into another with time.

Please note that since biological neurons, according to our hypothesis, are only field sources, since their cores only store the information of this field until the field is excited (as in remembering), and since thinking (and cognitive thinking as well) means generating fields in the moment of information processing during remembering, physical implementation of the CIS method for existing computers may require a mathematical representation of the cognitive memory, as disclosed herein, as a specific graph, where the edges of the graph are graph nodes, and the roles of graph nodes (i.e. whether they are considered nodes or connections) are determined depending on the situation, based on their relative locations, in strict accordance with the “one-over-one” rule. The “one-over-one” rule means that any two nodes may only be connected over a third node that would describe said connection. Besides, the mathematical model of the CIS system and method provides invariability of measuring objects relative to the environment by means of the relativity mechanism of measuring objects relative to one another, as described in the present disclosure.

To output information or produce some reaction, the claimed CIS system uses afferent nodes that interact with the environment. Afferent nodes are object/information object cores that contain values perceived by the CIS system when interacting with the environment. By using these values, the CIS system compares the nodes in its cognitive memory module 170 (see FIG. 1) with the information about the object that is obtained from the environment. Afferent nodes may be exemplified by words, phrases, signals and any other types of information that are received by the devices (particularly, digital computing devices), which operate as the converter 144, particularly, information input devices, such as a keyboard, image, speech, or sound recognizing devices, etc. Information may be outputted from the CIS system based on inputting new data using the CIS method, wherein new data may include a request to retrieve some cognitive information from the CIS system, particularly, its cognitive memory, or new data inputted into the CIS system and used by the system to react according to its established cognitive data structure, particularly, by means of data output devices, such as screens, manipulators, etc. Therefore, the logic stored using the CIS method, particularly, in the cognitive memory, may be activated and connected with the environment by means of various devices capable of processing data coming from the CIS system through the devices on the executive device level 125. Information may also be outputted using predictable causal connections in the cognitive memory, which may automatically turn on (used by the CIS system), when certain environmental conditions are met, or when a direct request to the memory has been made via the interface 172.

The system as shown in FIG. 1 also comprises a cognitive memory module (cognitive memory) 170, which is an information field of a certain structure according to the present disclosure, particularly, one implemented by a quasi graph according to the present disclosure, wherein the information/data is written into said field cumulatively in the form of cognitive data/cognitive frames 160 (e.g. obtained from the module 155 or from the user interface 172, see below). Also, said field is able to react to the information/data being written into it by transmitting (e.g., into the environment 140) its predictions either when certain environmental conditions occur, e.g. when there is a request to obtain information from the CIS system, particularly, its cognitive memory, or immediately. Such environmental conditions may include various situations of the physical world 142 of the physical world level 130 (see FIG. 1). For example, in response to a bright flash that has been detected by a sensor or a camera that send signals to the CIS system via the converter 144, which are then processed by the cognitive memory module 170, the CIS system is able to react depending on the logic selected by the CIS system based on the information stored in it in the form of at least one quasi graph or at least two connected quasi graph, wherein the CIS system reaction may be produced, for instance, by a device that is connected to the CIS system, particularly, after the information from the cognitive memory module has been converted into the data format readable by the converter 147 by means of the converter 180 (see below), and wherein the converter 147 may not only convert information, but also act on it, e.g. affect the physical world 142 and its elements. In particular, the converter 147 may be implemented as a computing device, such as a personal computer or a TV set, specifically, that is capable of displaying the information output from the CIS system to the user. Also, said converter may be implemented as a number of manipulators that are capable, for example, of transporting or otherwise manipulating the objects of the physical world 142.

The system illustrated by the FIG. 1 also comprises a data input interface/an I/O interface (not shown in FIG. 1) that may be implemented, for instance, as the user interface 172 or as the incoming information frame converter interface 144, or as a separate module, e.g. one located between the user interface 172 and the cognitive memory module 170, or between the physical world 142 and the CIS system, specifically, between the physical world 142 and the incoming information frame converter interface 144, connecting them; or one connecting the CIS system, specifically, its converter 147 of digital data into information frames of the environment format.

Cognitive memory is a structure that is capable of storing all the elements of how a person perceives the world (which have been converted into the cognitive memory format, particularly, by at least one of the converters 150 and 155, in advance), such as objects and their abstractions, connections between objects, including causal connections in the field graph that comprises fundamental environment objects/objects of the physical world 142, such as generalized object/proto-object, which is the highest degree of abstraction for all objects, wherein the highest degree of abstraction is both the representation of the environment 140 in the CIS system and the element values of the environment 140 that are required by the CIS system to recognize the logical structures of the environment. A degree of abstraction is the number of connections between the original object core along the path of input connections up to the object core, wherein its degree of abstraction is determined in relation to the original object. The highest degree of abstraction for any object may be a single indivisible object, which is also the environment or something that may be represented by the environment.

Also, the system illustrated by FIG. 1 may comprise an efferent cognitive converter, which is an algorithm (e.g. an immediately executed algorithm) that functions in an opposite way to the afferent cognitive converter 155, specifically, producing the reaction of the cognitive memory module 170 to the external information that has been inputted into the CIS system 105 and processed/converted (e.g. by the modules 155, 144), or to the external information that has been obtained by the cognitive memory module 170 in any other way, e.g. via the user interface 172. The data (particularly, cognitive frames/cognitive frame stream) that have been converted by the efferent converter 180 into the format of the converter 147 are passed on to the converter 147, where the executive devices (such as TV sets, displays, loudspeakers, printers, manipulators, signal generators, relays, etc.) transform the digital signal into the format that would be perceivable (comprehensible, processable, etc.) by the environment 140 of the physical world 130, such as screen image, electromagnetic impulses, etc. Thus, the artificial intelligence (implemented by the claimed CIS system, particularly, by its cognitive memory) is able to interact with the environment 140. Please note that the information outputted into the environment by the CIS system 105 may look like program code.

Information/data may be outputted from the CIS system into the environment 140 when certain conditions (e.g. an estimated probability of some situation) for the environment to perceive the information are met. In other words, according to one embodiment of the present invention, a cognitive mind, particularly, one implemented via the cognitive memory module 170, is capable of outputting information from the CIS system into the environment 140, if the cognitive mind supposes (or has calculated) that, based, for example, on calculated probability, it will get an answer (e.g. in the form of new input data for the CIS system) from the environment 140. Otherwise, the CIS system may not output information. For instance, the CIS system won't display information on the connected screen, for example, if nobody watches said screen. Also, the CIS system won't play information as sound, if there is nobody to hear it.

Please note that the decision to output the information from the CIS system into the environment may be formed in the cognitive memory module 170 at one point in time (e.g. in advance), but the information will be outputted as soon as the environment changes, i.e. the CIS system receives corresponding information about the changed state of the environment that would cause the prepared information to be outputted. Such changed state of the environment, which is transformed into an instruction to output the information from the CIS system into the environment, may be represented/implemented by establishing/registering a new connection between existing objects/information object, which have an abstract model of reaction to the information objects in the CIS system.

Please note that both afferent cognitive converters and efferent cognitive converters are represented by algorithms (which may be implemented as computer modules, or several computing devices, as well as computers or computer boards) for converting the information that is inputted into them or outputted from them either into a cognitive form, or from a cognitive form into immediate precise logic instructions, correspondingly.

In order to use the CIS method to systematize large amounts of information that is processed by the CIS system, the user interface 172 may be used (specifically, a user interface that is an example of a data input interface) that allows to input data into the cognitive memory in the form of ready-made cognitive information frames. Please note that the user interface 172 may be replaced by any data input interface that allows to add cognitive frames into the system 105, particularly, in its cognitive memory module. Such interface may be represented as a command line, an application API, etc. Therefore, both an afferent converter and an efferent converter are optional modules for the CIS system, shown in FIG. 1 as part of an exemplary embodiment of the claimed system and method.

As mentioned above, the CIS method is a set of actions/operations (executed, for example, by a computing device, specifically, an electronic computer) aimed at processing the environment information and presenting it in the format that is recognizable by the cognitive memory, so that the cognitive memory module 170 can process said information/data. The claimed CIS method and system allow to affect the environment 140 (e.g. as described above), e.g. through the devices that are connected to the CIS system, which, in turn, may generate new and/or additional information in the environment. Such information may be used to optimize the cognitive memory (particularly, to establish/create new connections between information objects in the quasi graph, to create new quasi graph, to create new connections between information objects and connections, etc.), e.g. by inputting/feeding such information into the CIS system via various data input devices, wherein inputted data is processed by the converter 144. According to one embodiment of the present invention, the CIS method utilizes a mathematical model of a “relativistic space-time information field” (information field, relativistic field), which is a part of the information systematization method. Specifically, the cognitive memory module 170 is represented by an information field (topological/relativistic field).

Intermediate nodes acs either as connections between afferent nodes and other intermediate nodes, or as connections between intermediate nodes. Intermediate nodes have input connections/inputs from afferent and/or intermediate nodes and represent object cores that are characterized by input and output connections to other objects and quasi graph nodes only. The set of intermediate nodes forms the logic of the claimed system. Intermediate nodes are created by the CIS system based on the objects from the information stream that have not been recognized.

Please note that the CIS method, based on information field properties, is capable of cognitively systematizing information to describe any environment, even a fictional one (e.g. plots of speculative fiction). Cognitive information systematization involves recognition of the logic of the data inputted into the CIS system, including causal connections between information objects, other information objects, and connections, as well as connections between information object connections and information object connections, in order to store them in the cognitive memory represented by the cognitive memory module 172.

The main properties of the information field used by the claimed CIS method include:
graph nodes representing information object cores, and input connections from other nodes to graph nodes representing attributes of information objects (hereinafter, the terms “object core” and “(graph) node” are viewed as synonyms). Input connections of the first degree of abstraction represent unique attributes of the object, while connections of higher degrees (second, third, etc.) represent abstract attributes, which the object is supposed to have, if this has not been denied, for example, by the means of the CIS system.

Any graph node may be both a connected node and a connection between two graph nodes. The property of relativity allows to implement the theory of embodied cognition, wherein the information inputted into the CIS system is stored in the cognitive memory in comparison with the previous information, and is described by itself. Such relativism attests that both the CIS method and the CIS system are cognitive. Cognitivity of the CIS method and the CIS system, according to the present disclosure, means that they are capable of storing the incoming information from the environment in full, based on the previously obtained information. In other words, cognitivity is a way of describing the incoming information using the information already stored in the CIS system, limited to connection of nodes, i.e. to establishing of individual relativity for new objects, which, in turn, reflects the relativity of both the CIS system and method. This approach expands the notion of cognitivity for it to be applied not only to a human mind, but to other system as well, including artificial systems, such as the CIS system. All cognitivity is based on relativistic principles, i.e. one thing is described through another thing, specifically, one information object is described through a different information object, e.g. its attributes.

Since connections are the cores of objects in the information field, we can talk about topological/logical (not numerical) connection weights, which are determined by connections to other objects. This allows to construct abstract structures of topological connection weights in a relativistic form, unlike numerical weights that are used, for example, in neural networks and that are limited in terms of dynamical optimization (i.e. it is impossible to revamp a neural network without losing all its training/self-training progress).

Connections represented by information field nodes have a topological connection weight, which is determined by input connections from other nodes to said node-connections. Please note that a connection is also an object. For instance, two nodes acting as connections may have a common/shared input abstraction node, and therefore it is possible to speak about homogeneous connection weight. For example, an abstract object “kilogram” may be created, which may be an input node for two objects “heavier than a person” and “lighter than a person”, wherein both may be used as connections in case, where it is important to provide physical weights of two objects relative to one another, describing them relative to a person's weight.

A node acting as a connection between two other nodes may be viewed differently, depending on the node it relates to, i.e., for instance, depending on which node describes the current node in a given case.

Objects having no input connections are regarded to have an input connection from the object of highest abstraction that has no input connections itself. Therefore, any information object (particularly, one represented by a graph/quasi graph node) would have an input connection path (i.e. a set of connections leading from one information object to another) that would lead to the object of highest abstraction. Such object may be called a proto-object, represented in the CIS system by at least one quantum quasi graph node, wherein quantum quasi graph nodes represent input connections/inputs for intermediate quasi graph nodes. From a cognitivist point of view, such object would denote the essence of the notion of “object” and establish that the entire information space is made up of objects. Given the fact that information field objects act as connections, and objects without input connections are connected to the proto-object, an information field model, from a cognitivist point of view, shows that the entire non-systematized space is filled with objects with input connections from the proto-object that acts as the highest-level abstraction for the majority of objects and connections.

Therefore, the claimed CIS method allows to unify information systematization of any level of logic or abstraction degree, specifically allowing to store both object abstraction structures and causal connections that arise when these objects change. For instance, first-order connections represent/describe the spatial structure, details and abstraction of objects. Second-order connections describe their changes in space, i.e. time. Third-order connections describe cause-and-effect connections between changes in space. connections of the fourth order and further describe other types of changes, which currently cannot be perceived by a human brain, but which may be used for scientific purposes to study processes in multi-dimensional spaces.

The level of depth (order) of logic represents the number of connections between objects (information objects) that, in relation to each other, act as connections between the initial connection and the connection, the order of which is computed/determined relative to the initial connection. In cognitive sense, the first level of depth of logic corresponds to abstractions, the second level of depth corresponds to spatial changes, and the third level of depth corresponds to causal connections.

Please note that data inputted into the claimed system (e.g. cognitive frames, particularly, new cognitive frames) may be stored by creating new connections and/or re-using the quasi graph connections that already exist. Therefore, one information object (or information entity) may be represented by different connections. In this case, the claimed system, particularly, using its cognitive memory module, selects a structure (chain) with the lowest number of connections (specifically, connections are the same as energy, where one connection equals one energy unit; therefore, the system would strive to minimize storing costs, i.e. to minimize the number of connections). For instance, in case there are two information objects both having the same set of graph nodes (specifically, afferent graph nodes), the afferent graph nodes that already exist are not duplicated, and the claimed system leaves only one information object, which is described by the graph nodes, while the other information object is assigned to a single graph node that has an input connection from the first object's node connected to said set of afferent graph nodes. The method of claim 1, further comprising transforming the at least one generated graph node (specifically, an afferent graph node) into at least one connection between graph nodes, and/or into at least one intermediate graph node, and/or into a different afferent graph node, and then storing at least one such graph node in the graph database.

The main difference between an information field and a connected directed graph is that in an information field, graph edges may be represented by graph nodes that belong to the same graph, while the node connecting other two nodes determines the topological (not numerical), i.e. logical, weight of the connection. The direction of a connection describes a space-time abstraction of objects “from the general to the specific”, wherein a connection always goes from an abstract object to a specific one, which incorporates the properties of an abstract object. Also, changes in an information field are accumulated along with the accumulation of information, but not through deletion or replacement of information field elements.

Since, as mentioned above, connections may be represented by nodes that also have connections that may also be represented by nodes, it is possible to speak about the depth (order) of logic, wherein each level of depth corresponds to the specific nature of field changes. First-order connections represent the abstraction depth. Second-order connections represent object changes caused by the passage of time. Third-order connections represent causal connections, and so on. This allows to create a continuous space-time model of interconnected information/data (within the CIS system) that is systematized using the CIS method. Please note that information relativism consists in that some objects are cumulatively described through their input connections to other objects as the CIS system obtains information, wherein objects from input connections are attributes of the object that has said input connections.

Also note that the CIS method does not view numbers as an independent tool, as the CIS method is based on object relativism, while numerical methods distort this principle. For instance, in the CIS system, numerical changes in objects are based on comparison connections between one group of objects (the quantity of which is known in advance) and other objects. For instance, ten fingers can be matched through connections to other ten objects. In fact, human brain can't carry out complex mental calculations if they involve more objects than can be touched. However, special needs may require to introduce the concept of numerical objects and to describe a mathematical apparatus (including formulas) that is used by people when solving mathematical problems without computers or calculators. Also note that the CIS system may use external tools so that the cognitive memory may send requests for precise calculations, when it needs to determine relations between objects and establish corresponding relativistic connections within itself, and receive responses thereto.

Environmental tools are external systems of precise logic that contain absolute values which can be used by the cognitive memory in order to establish causal connections in the information obtained. Also, external systems of precise logic may be used as a transition from absolute values to relativistic structures. For instance, a typical example would include physical constants, such as standards of measurement. Environmental tools may be used when the CIS method is applied both when information from the environment is inputted into CIS system and when information form the CIS system is outputted into the environment, since the environment exist it the world of absolute values, while the cognitive memory may contain any image of the environment, even the most bizarre from the physical point of view,

As described above, the cognitive memory is both invariant and relative, therefore, creation of precise logic platforms on this base requires tools for working with absolute values, such as global time, constants, units of measurement, etc. Just like a person consulting his or her schedule or notebook to remember the order of events or the dates of planned meetings, the cognitive memory may communicate with environment information tools via afferent nodes that allow to obtain absolute data from the environment and convert them into relative data inside the cognitive memory represented by the cognitive memory module 170. Real-time clock is one of the environmental tools. In addition to that, other absolute-value tools may be used, such as phone numbers, which cannot be considered cognitive data and thus should not be stored in the cognitive memory. Therefore, by using environmental tools, it is possible to cognitively control precise tools, wherein the cognitive system trained to use precise tools acts as an intermediary.

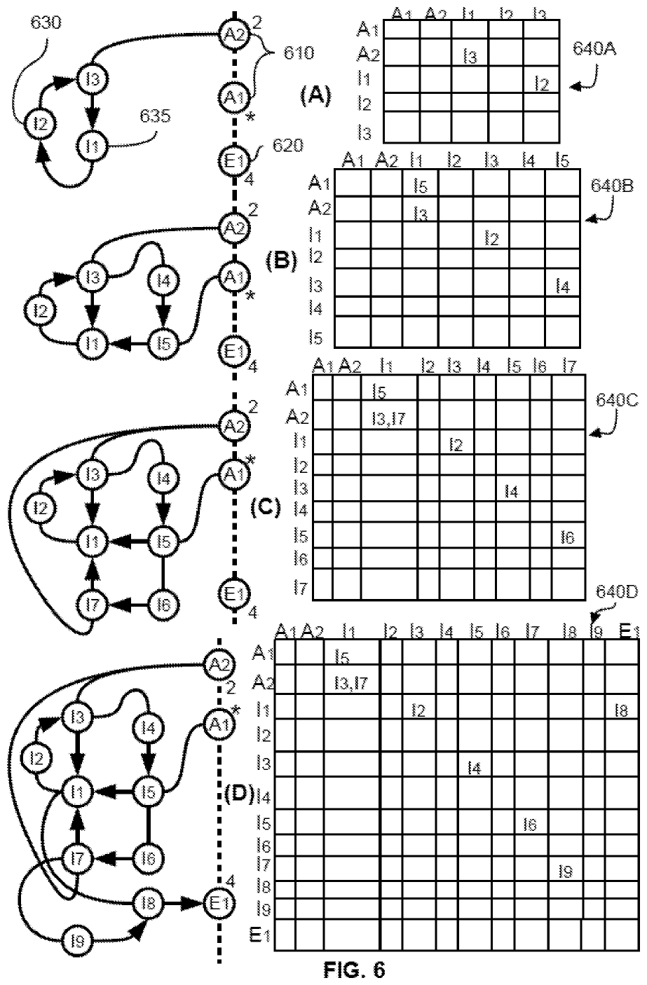

FIG. 2 shows an exemplary user interface implemented as a logic navigator that is used by the CIS system, particularly, to input data into the CIS system, e.g. to input data into the cognitive memory, as well as to output data from the CIS system, particularly, into the physical world, e.g. to visualize the data stored in the CIS system. The logic navigator may comprise a logic navigator panel 210. When the user selects an element of the logic navigator panel, they may view an attribute map/object card 280 that contains, for instance, the attributes of the selected element. The logic navigator panel may contain an active logic area, i.e. an area (element) of the logic navigator panel for the selected object 230. The active logic area 230 may contain a search line 240, which can be used to search for data, objects, quasi graph nodes, etc. that are stored in the cognitive memory or are a part of the environment, particularly, of the physical world 142 (see FIG. 1), as well as an active logic focus 220, wherein the focus may transform (or be transformed, e.g. by means of the instruction processing algorithm of the logic navigator panel) into, for example, a different sample logic focus 225 (as illustrated), depending on the change of the active logic focus, e.g. using up/down arrows in the command line 270 in the logic navigator panel. The user may use the command line to add (remove) objects, quasi graph nodes and connections between them to or from the CIS system (particularly, its cognitive memory implemented as a cognitive memory module 170), i.e. to train the CIS system. Also, the active logic area 230 may contain a list of connections 250, particularly, for the currently selected object (element of the logic navigator panel), e.g. a list of the connections between quasi graph nodes, objects and data stored in the cognitive memory and/or environment objects. Also, the logic navigator panel 210 may contain operative logic objects 260, particularly, those belonging to the selected object in the logic navigator panel, that may, for instance, include actions, which may be applied to the selected object. For instance, if the object “Locomotive Inv. No. 234-1” is selected, operative logic objects may include the objects “Stop the engine 124H14/16.5” and “Start the engine 124H14/16.5” that allow to start and stop the engine of the selected locomotive, i.e. include instructions for the device that controls the electric motor, or for the motor itself, the instructions belonging to efferent quasi graph nodes (620, see FIG. 6), i.e. the instructions being efferent quasi graph nodes according to the present invention. When the user selects an object in the logic navigator, he may view its attribute map (object card). Also, the user will see the entire chain of connections, and the user may view other attribute maps (object cards) without closing this chain.

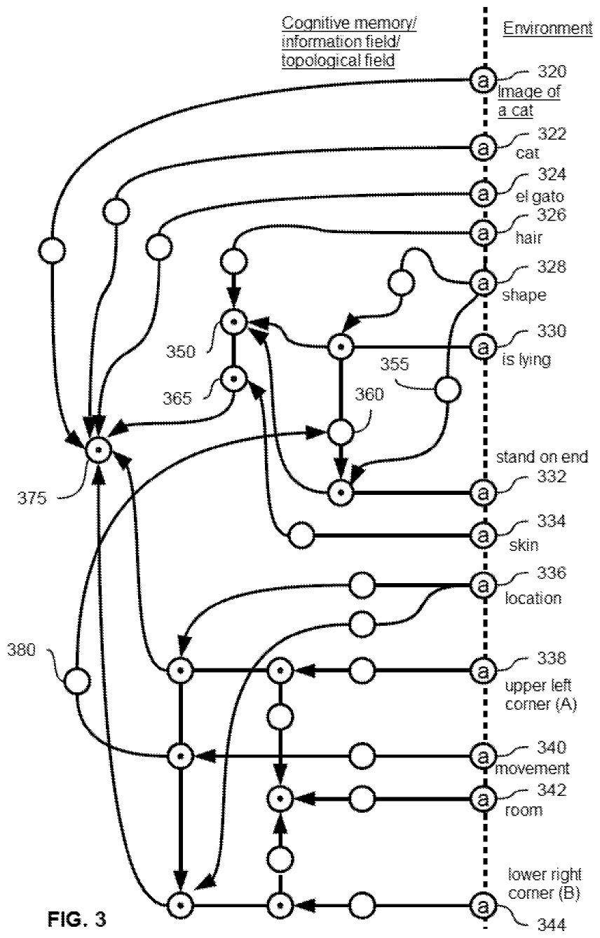

FIG. 3 shows an exemplary cognitive relativistic information field (topological field). Let's look at an exemplary method of cognitive information/data systematization according to the present invention. In order to implement information/data systematization, any database may be used, such as card index, network-based databases, relational databases, multidimensional databases, object-oriented databases, etc., including, e.g. graph databases, semantic databases, “entity-connection” type databases, and other types, and/or any other information systematization tool may be used, represented by, e.g. program code. If currently existing databases, particularly, graph databases, are used, information may be systematized, e.g. with regard to the differences between technical connections and methodological connections, as described in the present disclosure. A methodological connection, in particular, is an object that connects at least two different objects. A technical connection is some information/data about the connection direction and/or object connected through this connection. Therefore, when existing databases are used, particularly, graph databases, the connections in these databases may be technological connections.

Let's examine a situation, in which an object/information object “cat” is in a room (represented by at least the afferent node 342), and then it changes its location (represented by at least, the afferent node 336) by moving (represented by at least, the afferent node 340) from A, e.g. the far-left corner of the room (represented by at least the afferent node 338), to B, e.g. the far-right corner of the room (represented by at least the afferent node 344), and after the cat has moved to B, its hair stand on end (represented by at least the afferent node 332), after which the cat may lie down (represented by at least the afferent node 330). The information of this example may be described by quasi graph nodes in the topological field illustrated by FIG. 3, particularly, as demonstrated above. Also, the object “cat” may be described in various ways, e.g. with the image of a cat, or with the word “cat”/“KOωKa”, that are stored in the CIS system in the form of afferent nodes 320 (image of a cat), 322 (word “el gato” [cat in spanish]), and 324 (word “cat”), accordingly. Therefore, the object “cat” may be described in the CIS system by means of at least one node, e.g. at least one afferent node (here, it is described by means of three afferent nodes). Both the image of a cat and the words “cat”/“KOωKa” are specific representations of the object “cat”, so their corresponding afferent nodes 320, 322, and 324 may be connected to a single intermediate node 375. A cat has hair, which is represented by the corresponding afferent node 326 and the intermediate node 350. Cat's hair (350) is connected to the cat (375) through its skin (afferent node 334, intermediate node 365). The connection between cat's hair and the cat is an input connection, therefore, the object “cat” is a specific representation of the hair that is defined by the skin. Therefore, the cat and cat's hair are connected through the object “skin”. Such connections can be described as “a part of the whole” or “the general and the specific”, which is a feature of a first-order intelligence, as described above.

Please note that the information entity “cat” may be also described using afferent nodes: cat's paws, cat's tail, cat's hair, etc. When other information entities are added (created), other information entities may be created as well, and their descriptions do not have to be directly connection to any afferent node; their descriptions may be connected through at least one intermediate node. Please note that, in the example illustrated by FIG. 3, the information entity “is lying” is an information entity “action”, however, the words “is lying” don't have to be represented by an afferent node; they may be described by a set of different graph nodes (e.g. intermediate nodes and/or afferent nodes).

In an exemplary embodiment, an information entity is an object that is defined by a set of nodes and connections between them. A quasi graph node, which is a part of an information entity, should have at least one ascending tract to an afferent graph node.

Changes in object properties, such as movement from A to B, eye blinking, hair standing on end, are one way human brain perceives time. Objects that act as connections between objects acting as connections between abstractions are represented by objects that describe said changes, and which are usually represented by verbs. This reflects/describes a second-order intelligence, i.e. one capable of perceiving time. One such way may be a time measurement system in relation to atomic fluctuations (e.g. atomic clock). Connections between connections are known as causal connections, which describes a third-order intelligence that is characteristic of a human. In this way, a human brain is capable of storing information, when one change affects the other. Currently, a human brain is incapable of perceiving fourth-order connections, since their logic is incomprehensible (at this stage of human evolution, there are no physiological mechanisms that would enable it).

Thus, the description above relates to input connections going from afferent nodes in the dictionary (of afferents) of the CIS system. However, please note that reverse connections are also possible, i.e. input connections going to afferent nodes. In other words, such connections send signals to the environment and affect it, particularly, environment objects. Such nodes are known as efferent nodes. Using such descriptions provided by the claimed method, it may be possible to describe and demonstrate (particularly, by means of various devices connected to the CIS system, e.g. devices described above) the reaction of the CIS system to external things, such as environment information that has been obtained by the CIS system.

By means of the embodiment of the present invention as disclosed herein, the CIS system is capable of re-using the information that has been stored over time (in the form of datasets and quasi graphs/quasi graph nodes) to present new information or known information in a novel format. Therefore, the more information (i.e. experience) is stored (accumulated) in the CIS system, the less resources (particularly, hardware resources) the CIS system would require to memorize/store new information. For instance, if a person sees a vehicle, being an experienced car mechanic, this person would remember seeing a vehicle (in the CIS system, this event may be stored in the form of a quasi graph connection: exemplification of the object “vehicle”, its geolocation and connections to verb objects describing its relation to the time parameter, so that the system has information about the time, when the vehicle was seen). When the person would need to answer a question related to that vehicle, they would be able, based on their experience (memorized information), to describe the vehicle's operation and behavior. When the CIS system would receive a request related to the vehicle's operation and behavior, it would be able to answer such request based on its accumulated experience (stored information).

In the figure, the intermediate node 355 reflects a first-order intelligence, i.e. it is an abstract connection between the general and the specific. The intermediate node 360 reflects a second-order intelligence that perceives time through changes, particularly, describes change as a time function. The intermediate node 380 reflects a third-order intelligence, when one change influences the other change in the cause-and-effect way, as described above.

Please note that the nodes that are stored in the graph may be used to create at least one intermediate node and/or at least one afferent node and/or at least one efferent node and/or at least one quantum node.

Also note that the set of intermediate nodes that are stored in the graph form a logic that may be used at least to systematize the information that is stored in the graph in the form of nodes.

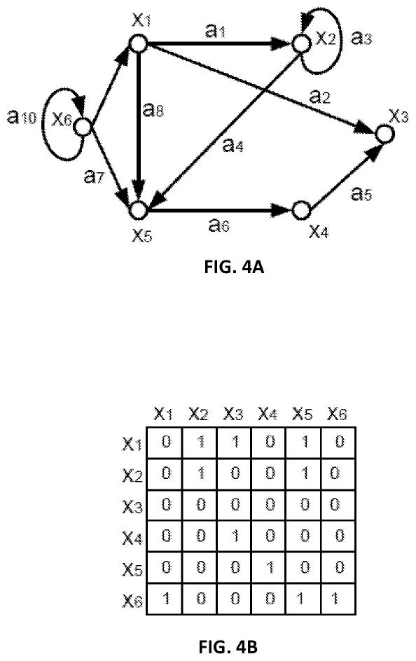

FIG. 4 shows a generic graph and an exemplary graph entry in the form of a matrix. FIG. 4A shows an exemplary graph. FIG. 4B shows an exemplary adjacency matrix for the graph shown in FIG. 4A, which is one of the methods for representing a graph as a matrix that can be used to determine the properties of vertices of such graph. For instance, the sum of elements in the i^{th} line of the matrix is the outdegree of the xi vertex, and the sum of elements in the i^{th} column of the matrix is the indegree of the xi vertex. The adjacency matrix may be used to find direct and inverse mappings. Let's look at the i^{th} line of the matrix. If the element aᵢⱼ=1, then the element of the xⱼ graph is in the mapping D(xᵢ). For example, in the 2^{nd} line of the matrix A (FIG. 1.5,b), ones are in the 2^{nd} and 5^{th} columns, therefore, D(x₂)={x₂, x₅}.

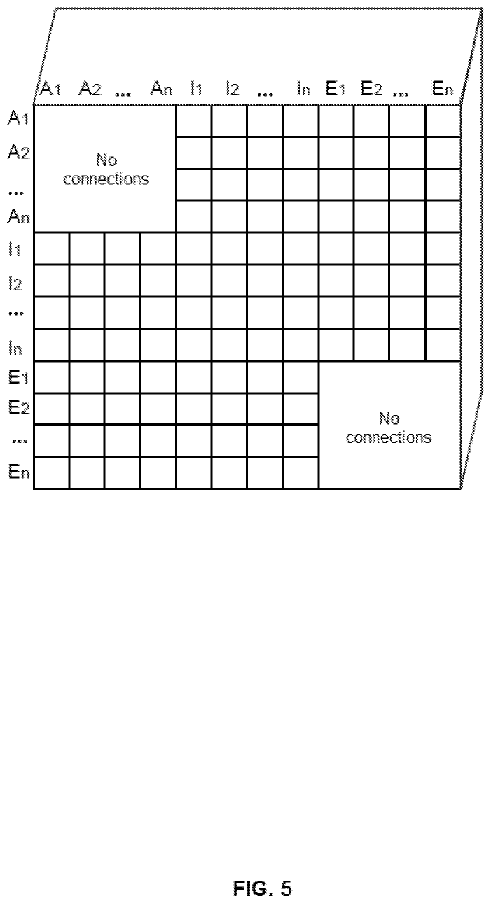

FIG. 5 shows a matrix (particularly, an adjacency matrix) of an information field/topological field (represented by a quasi graph) according to the present invention.

Information field matrix consists of an area of afferent nodes (A1-An), intermediate nodes (I1-In), and efferent nodes (E1-En).

Since in the CIS system, the graph is represented by a quasi graph, where, in an exemplary case, the connections within the graph are also represented by nodes, the claimed CIS method may use both at least one two-dimensional matrix and at least one three-dimensional matrix, where the third dimension points to the node acting as a connection,—unlike a classic description of a graph with a two-dimensional matrix, where 1 or 0 may mean that there is a connection. Please note that there may be several connections between two graph nodes, and, accordingly, there may be several graph nodes acting as connections. Therefore, in an exemplary case, a matrix is a three-dimensional matrix, where the third dimension is made up of the same graph nodes, arranged along the Z axis, and 1s and 0s on intersections, which show that there is a connection going through a given Z-axis graph node, i.e. in an exemplary case, the cells of said three-dimensional matrix contain 1s and 0s, while the Z axis contains graph nodes, and those nodes that are used as connections are marked with 1s.

Graph nodes that have been generated by means of the claimed system may be stored (particularly, in the cognitive memory according to the present disclosure) in the form of unique identifiers in at least one database represented by at least one matrix (including a three-dimensional matrix, particularly, one, where the intersections of its X, Y, and Z axes contain 1s and 0s, and the axes themselves act as IDs or afferents, as described in the present disclosure, in case they represent afferent nodes) in machine-readable memory (RAM, ROM, HDD, etc.) of the computing device (on which the claimed system and method may be implemented) or of an external device (e.g. a PC, a server, etc.) that is connected to said computing device, e.g. via a wired connection (USB, etc.) or a wireless connection (Wi-Fi, Bluetooth, etc.).

Therefore, since there are no direct connections between afferent nodes and efferent nodes, these areas in the information field matrix, as shown, are empty. To simplify the description, the third dimension is not shown in the figure, and the names of nodes located along the third axis are provided in matrix cells, after a comma, as will be shown in FIG. 6, which illustrates exemplary training and functioning of the CIS system.

FIG. 6 shows exemplary training and functioning of the CIS system, wherein information is stored in the form of a graph and an adjacency matrix.

Let's see an example, in which the claimed system contains afferent nodes 610 capable of receiving digits from 1 to 9 (e.g. from the environment/physical world) and the multiplication sign.

The afferent node A2 represents the number 2 (A2=2), e.g. it contains a value of 2, while the afferent node A1 represents the multiplication sign “*” (A1=*), e.g. it contains a value corresponding to the multiplication sign. Also, in this case, the claimed system may contain an efferent node E1 representing an instruction, specifically, a “instruction 4” (E1=instruction 4), i.e., in this particular case, it contains the reaction of the claimed system, e.g. an instruction to display the digit “4” on the screen, or to voice “the answer is four” through the loudspeakers connected to the system, etc.

Then, if one needs to obtain a result of multiplication of the afferent node A2 by itself, e.g. inputted into the system as a text combination like “2*2”, the claimed system starts reading this combination from left to right, just like a human does (the direction of reading matters, since a text combination like “5-2” is not the same as “2-5”), effectively starting calculating the given mathematical operation. The system sees the first symbol, “2”, and stores it in its cognitive memory using the claimed CIS method, i.e. generates the matrix 640 (that appears as 640A). The connection I2 represented by the intermediate node 630 demonstrates/reflects inception of the object. Just like in nature, the object is further generated around the node spiral-wise, i.e. exponentially. If I2 has no connection entries in the matrix, then I2 has an input connection from a quantum node described above in the present disclosure.

Then, while reading on the text combination “2*2”, the system recognizes the multiplication sign “*”, which is then also stored in the matrix 640 (that appears as 640B). Therefore, the matrix 640B contains “2*”.

Then, the system recognizes the second two in the text combination “2*2” and stores it in its cognitive memory, so that the matrix 640 appears as 640C.

Then, the system is trained, particularly, by a human operator, e.g. via the user interface as described above, who instructs the claimed system that the reaction to the text combination “2*2” is “instruction 4”, e.g. indicator instruction with the digit “4”.

As has been mentioned above, when different information is stored cumulatively in the CIS system using the claimed method, the stored bits of information, particularly, ones that intersect one another and are reflected in the form of quasi graph nodes, cause an associative memory effect, akin to the associative memory effect in the human brain. Therefore, if the CIS system finds no direct instruction about a reaction, the CIS system is able to analyze (run through the nodes and connections in the quasi graph) reactions contained in the nodes connected to efferent nodes, from the closest to the farthest ones. As also has been mentioned above, upon receiving a feedback from the environment, the CIS system would compare said feedback with the information it obtained through creating connections between the nodes in the quasi graph.

After some time (e.g. immediately after the first run through the nodes in the quasi graph that relate to said text combination “2*2”), the CIS system itself, or a human operator/user of the system (e.g. via the user interface) may create an afferent object (particularly, an afferent node) “2*2”, so that the claimed CIS system won't have to run through the matrix (particularly, the quasi graph nodes) again searching for said reaction, as the claimed system will immediately point at the needed object (particularly, the node), i.e. the afferent object (particularly, the afferent node) “2*2” that already exists in the CIS system (particularly, stored in its cognitive memory). To achieve that, an I10 node may be created in the CIS system (either by the CIS system itself or by a human operator/user), the node having an input connection from the intermediate node I1 635. Also, an input connection from the afferent node “2*2” may be created. In this case, the claimed CIS system does not have to read the text combination “2*2” from left to right (e.g. symbol by symbol). Human speed reading training works in a similar way, i.e. in the end a person starts perceive “2*2” not as a text, but as an image that doesn't have to be read from left to right, symbol by symbol.

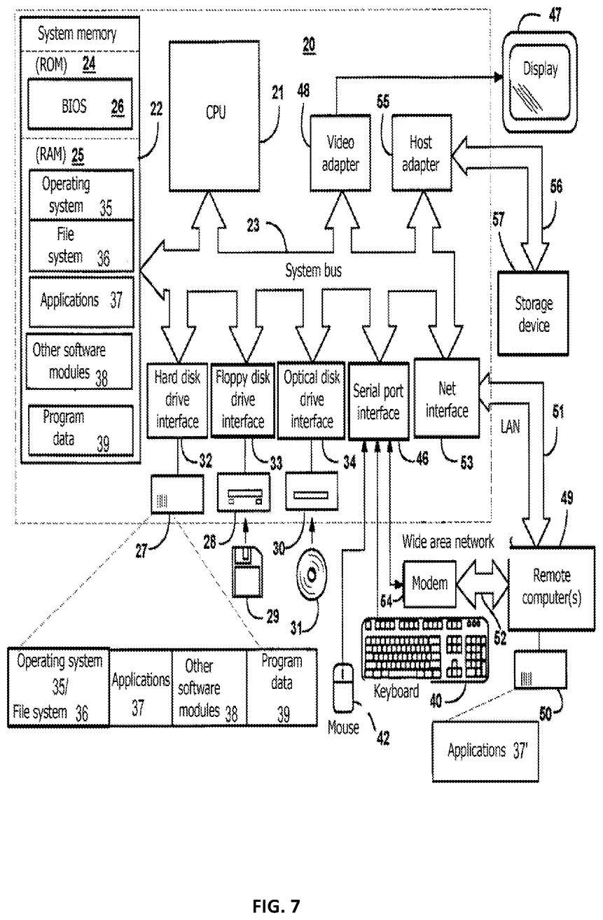

FIG. 7 shows an exemplary general-purpose computer system comprising a multi-purpose computing device—a computer 20 or a server comprising a CPU 21, system memory 22 and system bus 23 that connects various components of the system to each other, particularly, the system memory to the CPU 21.

The system bus 23 can have any structure that comprises a memory bus or memory controller, a periphery bus and a local bus that has any possible architecture. The system memory comprises a ROM (read-only memory) 24 and a RAM (random-access memory) 25. The ROM 24 contains a BIOS (basic input/output system) 26 comprising basic subroutines for data exchanges between elements inside the computer 20, e.g. at startup.

The computer 20 may further comprise a hard disk drive 27 capable of reading and writing data onto a hard disk (not illustrated), a floppy disk drive 28 capable of reading and writing data onto a removable floppy disk 29, and an optical disk drive 30 capable of reading and writing data onto a removable optical disk 31, such as CD, video CD or other optical storages. The hard disk drive 27, the floppy disk drive 28 and optical disk drive 30 are connected to the system bus 23 via a hard disk drive interface 32, a floppy disk drive interface 33 and an optical disk drive interface 34 correspondingly. Storage drives and their respective computer-readable means allow non-volatile storage of computer-readable instructions, data structures, program modules and other data for the computer 20.

Though the configuration described here that uses a hard disk, a removable floppy disk 29 and a removable optical disk 31 is typical, a person skilled in the art is aware that a typical operating environment may also involve using other machine-readable means capable of storing computer data, such as magnetic tapes, flash drives, digital video disks, Bernoulli cartridges, RAM, ROM, etc.

Various program modules, including an operating system 35, may be stored on a hard disk, a floppy disk 29, an optical disk 31, in ROM 24 or RAM 25. The computer 20 comprises a file system 36 that is connected to or incorporated into the operating system 35, one or more applications 37, other program modules 38 and program data 39. A user may input instructions and data into the computer 20 using input devices, such as a keyboard 40 or a pointing device 42. Other input devices (not illustrated) may include microphone, joystick, gamepad, satellite antenna, scanner, etc.

These and other input devices are connected to the CPU 21 usually via a serial port interface 46, which is connected to the system bus, but can also be connected via other interfaces, such as parallel port, game port, or USB (universal serial bus). A display 47 or other type of visualization device is also connected to the system bus 23 via an interface, e.g. a video adapter 48. Additionally to the display 47, personal computers usually comprise other peripheral output devices (not illustrated), such as speakers and printers.

The computer 20 may operate in a network by means of logical connections to one or several remote computers 49. One or several remote computers 49 may be represented as another computer, a server, a router, a network PC, a peering device or another node of a single network, and usually comprises the majority of or all elements of the computer 20 as described above, though only a data storage device 50 is illustrated. Logical connections include both LAN (local area network) 51 and WAN (wide area network) 52. Such network environments are usually implemented in various institutions, corporate networks, the Intranet and the Internet.

When used in a LAN environment, the computer 20 is connected to the local area network 51 via a net interface or an adapter 53. When used in a WAN environment, the computer 20 usually operates through a modem 54 or other means of establishing connection to the wide area network 52, such as the Internet.

The modem 54 can be an internal or external one, and is connected to the system bus 23 via a serial port interface 46. In a network environment, program modules or parts thereof as described for the computer 20 may be stored in a remote storage device. Please note that the network connections described are typical, and communication between computers may be established through different means.

In conclusion, it should be noted that the details given in the description are examples that do not limit the scope of the present invention as defined by the claims. It is clear to a person skilled in the art that there may be other embodiments that are consistent with the spirit and scope of the present invention.

What is claimed, is:

1. A method for storing data that is executed on an electronic computing device, the method comprising the following steps:
obtaining information about an information object from the environment in the form of a dataset;
generating at least two information entities from the dataset, wherein the second information entity is the binding property of the first information entity in the form of two afferent graph nodes;
generating at least one intermediate graph node for each of the two afferent graph nodes, wherein the at least one intermediate graph node has at least one input from at least one afferent graph node or intermediate graph node;
generating connections between the first afferent graph node and the second afferent graph node, wherein said connections are made through intermediate graph nodes; and
storing the generated graph nodes in at least one graph database that is represented by at least one matrix in machine-readable memory of said electronic computing device or of an external device that is connected to said electronic computing device.

2. The method of claim 1, wherein each graph node is stored in the form of a unique identifier.

3. The method of claim 1, wherein each graph node is assigned a unique identifier, when being stored.

4. The method of claim 1, wherein the connection between the first afferent node and the second afferent node is made through an intermediate graph node.

5. The method of claim 1, further comprising creating an intermediate node that results from the connecting:
at least one afferent node to at least one intermediate graph node,
or at least one afferent node to at least one afferent graph node,
or at least one intermediate node to at least one intermediate graph node.

6. The method of claim 1, further comprising the following steps:
from the dataset or a different dataset, generating an information entity that is an action performed on at least one information entity of claim 1, in the form of an efferent graph node; and
generating at least one connection between at least one intermediate graph node and the efferent graph node.

7. The method of claim 6, wherein connections to efferent nodes are generated based on the analysis of graph nodes, and/or the creation of afferent graph nodes and/or intermediate graph nodes.

8. The method of claim 1, wherein said graph is a quasi graph, in which at least one connection between at least two connections in the graph is stored in the form of at least one node, and/or at least one connection between at least two graph nodes is stored in the form of at least one graph node, and/or at least one connection between at least one graph node and at least one connection is stored in the form of at least one graph node.

9. The method of claim 1, wherein obtaining information about an information object from the environment in the form of a dataset is carried out through a data input interface.

10. The method of claim 1, wherein data input interface implemented by the user interface and allows at least one input dataset to be entered.

11. The method of claim 1, wherein the generated graph nodes are used to create at least one intermediate graph node and/or at least one afferent graph node and/or at least one efferent graph node.

12. The method of claim 1, wherein a set of generated intermediate graph nodes constitute a logic that is used to systematize the information that is stored in the graph in the form of generated nodes.

13. The method of claim 1, wherein datasets contain information about at least one environment object and a description thereof.

14. The method of claim 1, wherein an intermediate node is a first-order intelligence representing an abstract connection between environment objects, from the general to the specific.

15. The method of claim 1, wherein an intermediate node is a second-order intelligence that characterizes changes in environment objects as a time function.

16. The method of claim 1, wherein an intermediate node is a third-order intelligence representing a causal connection between datasets and/or environment objects.

17. The method of claim 1, wherein environment objects are recognized by comparing generated graph nodes and/or connections between them.

18. The method of claim 17, wherein intermediate nodes are generated for an unrecognized environment object, wherein no afferent graph nodes or efferent graph nodes had been generated for said unrecognized environment object before.

19. The method of claim 18, wherein an unrecognized object is recognized using at least one dataset corresponding to that unrecognized object and that has been stored in the form of an afferent graph node, and/or using at least one database that has been stored before in the form of an afferent graph node, and/or using at least one intermediate graph node that has been created before.

20. The method of claim 19, wherein the at least one dataset stored in the form of an afferent graph node, and/or at least one intermediate graph node describes an environment object that is different from the unrecognized environment object, wherein connections are created between such afferent graph nodes and/or intermediate graph nodes to connect them to afferent graph nodes and/or intermediate graph nodes, said connections describing the unrecognized environment object in order to accumulate information about logical connections between recognized environment objects and the unrecognized environment object, thus predicting the behavior of said environment object.

21. The method of claim 1, wherein generating of information entities includes the use of a dictionary of afferent meanings, in which each afferent value is associated with at least one graph node.

22. The method of claim 21, wherein information entity is connected with an afferent node by at least one intermediate node.

23. The method of claim 21, wherein the afferent nodes contain data transformed by an afferent cognitive converter, characterized by the ability to transform a set of data into at least one cognitive frame, which is at least one information structure, the elements of which are cognitive quanta of information/pieces of information that are indivisible for the intellect.

24. The method of claim 1, wherein generating of at least one graph node in the form of a quantum graph node, which is the highest degree of abstraction and an input for at least one intermediate graph node and containing a description of the data set.

25. The method of claim 1, wherein the matrix is implemented by a three-dimensional matrix, the intersection of the X, Y and Z axes of which contains ones and zeros, and the matrix axes are identifiers (ID) or afferent values.

26. The method of claim 1, further comprising transforming the at least one generated graph node into at least one connection between graph nodes, and/or into at least one intermediate graph node, and/or into a different afferent graph node, and then storing at least one such graph node in the graph database.

27. A system for storing and processing data, comprising:
a data input interface for inputting information about an info object in the environment and for converting the putted information into at least one dataset;
an information converter that converts the information into at least one dataset and sends the dataset into an afferent cognitive converter;
an afferent cognitive converter represented by a software module for converting the dataset into cognitive frames, the cognitive frames being information structures consisting of cognitive information quanta that are discrete for an intelligence, wherein at least two information entities are generated from the dataset, wherein the second information entity is the binding property of the first information entity;
a cognitive memory software module that is capable of:
creating and storing information structures as afferent graph nodes;
creating and storing intermediate graph nodes for afferent graph nodes, wherein intermediate graph nodes have at least one input from at least one afferent graph node or intermediate graph node; and
creating and storing connections between afferent graph nodes, wherein said connections are made through intermediate graph nodes.

28. A system of claim 27, further comprising the creation and storage by the cognitive memory module of at least one data set of an information entity, which is an action performed on at least one information entity, in the form of an efferent graph node.

29. A system of claim 27, further comprising storing by the cognitive memory module of the graph nodes in the form of unique identifiers in at least one graph database implemented by at least one matrix in the computer-readable memory of said computing device or external device connected with said computing device.
